(19) United States
(12) Patent Application Publication
(10) Pub. No.: US 2010/0262315 A1
(43) Pub. Date: Oct. 14, 2010

(54) HOUSEHOLD APPLIANCE, IN PARTICULAR DISHWASHER

(75) Inventor: Michael Rosenbauer, Reimlingen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERÄTE GMBH, Munich (DE)

(21) Appl. No.: 12/745,698

(22) PCT Filed: Nov. 5, 2008
(86) PCT No.: PCT/EP08/65004

§ 371 Date: Jun. 2, 2010

(30) Foreign Application Priority Data
Dec. 5, 2007 (DE) 10 2007 058 382.8

(51) Int. Cl. G06F 1/32

(52) U.S. Cl. 700/296

(57) ABSTRACT

A household appliance and method of controlling the household appliance. In an exemplary embodiment, the household appliance, such as a dishwasher, may include a control element structured to control the household appliance; a power supply structured to supply power to the household appliance; at least one display element for displaying at least one of an operating state and data about the household appliance; and a control device structured to supply electrical energy from the power supply, by actuation of the control element, to the at least one display element, and at least one of reduce and interrupt the power supply to the display element after a preset time period.

The invention relates to a household appliance, in particular a dishwasher, according to the preamble of claim 1.

Modern household appliances, in particular dishwashers, are nowadays provided with a plurality of displays, i.e. LEDs and/or LC displays, which are supplied with energy by way of an electrical control device.

DE 43 11 935 A1 discloses an electric cooker as a generic household appliance, in which, after actuating a control element, a control device supplies electrical energy to an associated display element for displaying an operating state and/or other data. Switching means for a clock are tangibly connected here to control elements provided in the control panel of the cooker. When the cooker is switched off, the clock is disconnected from the mains power supply in order to save energy. The clock is only activated when a control element is actuated.

The clock display is continuously connected to the electrical mains power supply during the entire operating time. Other display elements can also be operated to some extent prior to a program start and/or after the end of a program. An undesirably high energy consumption may result when viewed on a continuing basis.

The object of the invention consists in providing a household appliance, in particular a dishwasher, in which the energy consumption is reduced.

The object is achieved by the features of claim 1. Preferred developments of the invention are disclosed in the subclaims.

According to claim 1, the control device reduces or interrupts the power supply to the display element after a preset time period. I.e. within this preset time period, the operating person can monitor the setting of the household appliance performed on the control element on the basis of the display element supplied with electrical energy, for instance an LC display. Once the preset time period has elapsed, the control device then reduces and/or interrupts the power supply to the display element. Alternatively, after the preset time period has elapsed, a minimum display, e.g. an LED can also be operated. When considered in the long run, this results in a significant energy saving and thus also in a longer service life for the display elements

The control device can preferably supply the display element with energy at predetermined clock intervals and/or reduce or interrupt the energy supply. The operating person can in this way also obtain information relating to the operating state when the preset time period has elapsed.

In a further embodiment, an additional information switching element can be provided instead of the afore-cited cyclical operation of the display element or in combination with the cyclical operation. When said information switching element is actuated, the control device can reproduce the power supply to the display element once the preset time period has elapsed. The information switching element can be provided in a control panel of the household appliance together with the further control and display elements. With the information switching element, contrary to the further control elements, no operating parameters or suchlike can be set, but instead only the power supply to the display elements can be reproduced. The display elements are thus only then illuminated and/or activated if the operating person wishes to obtain information relating to the operating state by actuating the information switching element. Accordingly, after actuating the information switching element, the control device can again interrupt or reduce the power supply to the display element after a further preset time period.

For simple and reliable operability of the household appliance, at least one operating display element can be provided on the household appliance in the case of a plurality of display elements, said operating display element continuously indicating the operating state of the household appliance, irrespective of an actuation of the information switching element. This herewith ensures that the operating person also obtains at least one acknowledgement even in the case of an off time period in the afore-described cyclical operation and/or after the afore-cited preset time period has elapsed, said acknowledgement indicating whether the household appliance is switched on or off. With a further, detailed information demand, the operating person can also control the information switching element, as a result of which the remaining display elements also illuminate.

Two exemplary embodiments of the invention are described below with the aid of the appended Figures, in which:

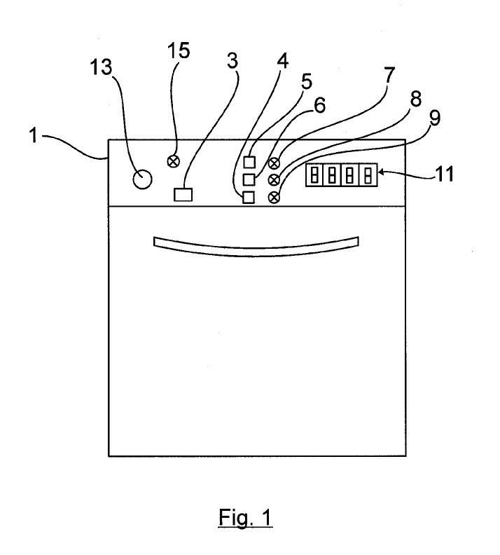

FIG. 1 shows a front view of a dishwasher in accordance with the first exemplary embodiment;

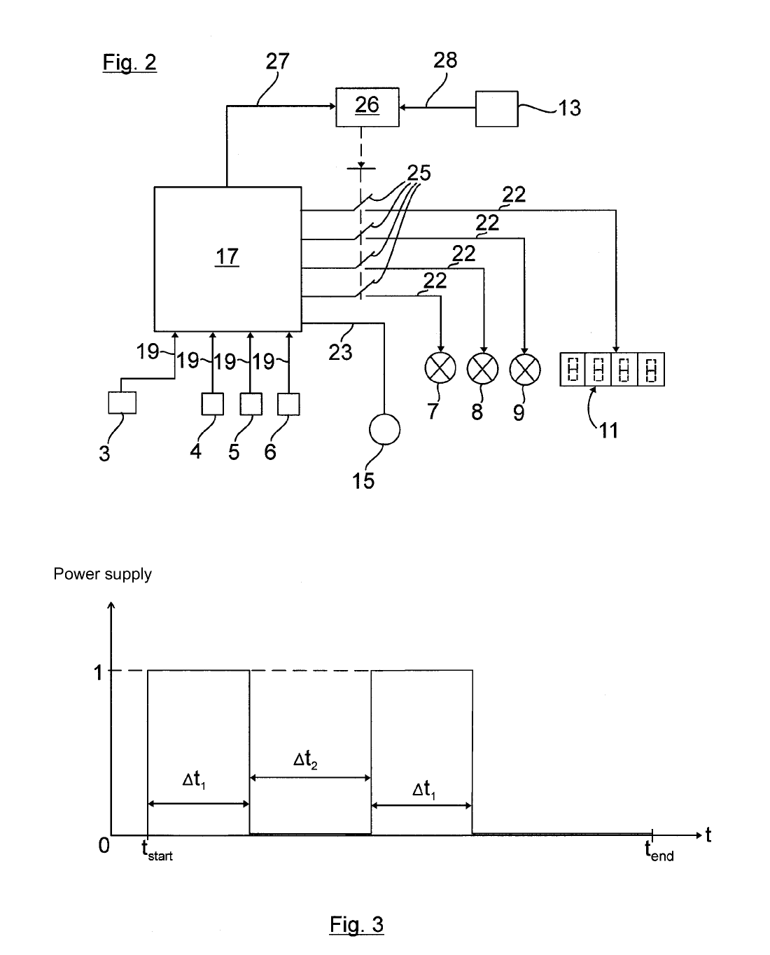

FIG. 2 shows a very schematic representation of a block diagram of a control device with assigned control and display elements;

FIG. 3 shows a time diagram for illustrating the operating states of the display elements;

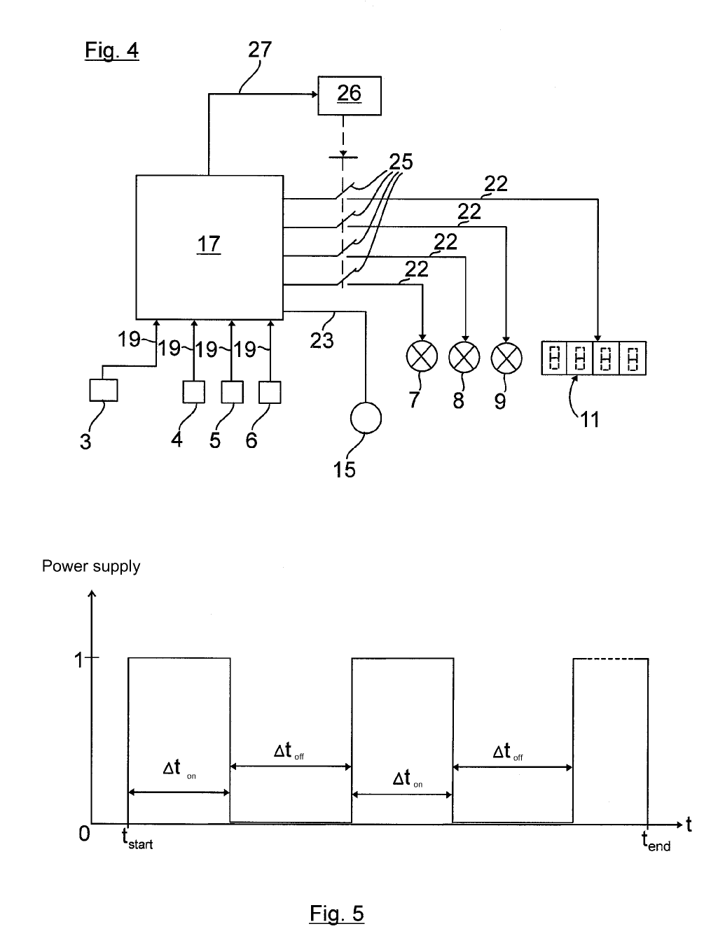

FIG. 4 shows a block diagram according to the second exemplary embodiment in accordance with FIG. 2; and

FIG. 5 shows a time diagram according to FIG. 3.

FIG. 1 shows a dishwasher according to the first exemplary embodiment with a control panel 1, which has a number of operating and display elements. A main switch 3 for switching the dishwasher on and off as well as three program switches 4, 5, 6 are provided in each instance with respectively assigned display elements 7, 8, 9 as a control element. The control elements 3 to 6 are in each instance push-buttons for example, while the display elements 7 to 9 are embodied by way of example as LED displays. Furthermore, a display 11 with four seven-segment displays is also provided in the control panel 1, for instance for the purpose of program displays and/or remaining period displays.

Aside from the afore-cited operating and display elements, a subsequently described information switching element 13 and an operating display element 15 are also provided in the control panel 1, said operating display element 15 being likewise embodied as an LED display. To start up the dishwasher, the main switch 3 is initially pressed and a corresponding washing program is then set by means of the control elements 4, 5, 6. When actuating one of the control elements 4, 5, 6, the corresponding washing program starts. Additional information relating to the washing program is shown in the display 11.

As apparent from FIG. 2, a control device 17 is assigned to the control and display elements, said control device 17 being connected to the control elements 3 to 6 by way of signal lines 19. Furthermore, the control device is connected to the display elements 7, 8, 9, 11 by way of signal lines 22 and to the operating display element 15 by way of the signal line 23.

As apparent from FIG. 2, a switch 25 is operated in each of the signal lines 22. The switches 25 provided in the signal lines 22 are actively connected to a timing element 26, which can be actuated by the control device 17 by way of a control line 27 and opens or closes the switches 25 depending on the operating state.

Following a program start effected by actuating the main switch 3 and one of the program switches 4, 5, 6, the control device 17 controls the switches 25 by way of the timing element 26, in order to close the signal lines 22 to the display elements 7, 8, 9, 11. In this way, the control device 17 can supply the display elements 7, 8, 9, 11 with energy during a time period Δt₁ which is preset by the timing element 26. After the predetermined time period Δt₁ has elapsed, the timing element 26 of the control device 17 opens the switches 25 so that the power supply to the display elements 7, 8, 9, 11 is interrupted.

After the time period Δt₁ which is preset by the timing element 26 has elapsed, the operating person can manually actuate the information switching element 13. The information switching element 13 is connected to the timing element 26 of the control device 17 by way of a further control line 28. Manual actuation of the information switching element 13 enables the timing element 26 to be reactivated, so that it keeps the switches 25 closed during the preset time period Δt₁.

FIG. 3 shows a time diagram to illustrate the second exemplary embodiment.

Accordingly, when the program is started at time instant tₛₜₐᵣₜ, the control device 17 closes the switches 25 by way of the timing element 26, as a result of which the display elements 7, 8, 9, 11 are supplied with electrical energy during the time period Δt₁. After the time period Δt₁ has elapsed, the timing element 26 opens the switches 25 in the signal lines 22, as a result of which the power supply to the display elements 7, 8, 9, 11 is interrupted for an undefined time period Δt₂. In contrast, the operating display element 15 continuously illuminates irrespective of the operating state of the display elements 7, 8, 9, 11.

The undefined time period Δt₂ is terminated if the operating person actuates the information switching element 13, as a result of which the timing element 26 is once again activated and closes the switches 25 of the signal lines 22 for the time period Δt₁.

After the time interval Δt₁ has again elapsed, the timing element 26 once again interrupts the power supply to the display elements 7, 8 , 9, 11 so that the washing program is continued until the program end time instant t_{end} when the display elements 7, 8, 9, 11 are not activated.

FIGS. 4 and 5 relate to the second exemplary embodiment. The block diagram shown in FIG. 4 is essentially identical to the block diagram in FIG. 2, so that reference can be made to the description thereof. Contrary to FIG. 2, the second exemplary embodiment dispenses with the information switching element 13. The operating person is therefore not able to manually restore an power supply which is interrupted by the timing element 26 to the display elements 7, 8, 9, 11.

On the other hand, the timing element 26 shown in FIG. 4 is embodied such that it closes and/or opens the switches 25 during preset on and/or off time periods Δtₒₙ and Δt_{off}. In this way, the display elements 7, 8, 9, 11 are supplied with energy in a predetermined clock frequency and/or the power supply is interrupted, as shown in the time diagram of FIG. 5.

The two exemplary embodiments can be combined arbitrarily with one another. It may be particularly advantageous in respect of ease of use to also assign the information element 13 shown in FIG. 2 to the timing element 26 shown in FIG. 4. In this way, the power supply to the display elements 7, 8, 9, 11 takes place on the one hand in the afore-mentioned cyclical operation. On the other hand, the power supply to the display elements can be reproduced depending on customer wishes at any time by actuating the information switching element 13.

### LIST OF REFERENCE CHARACTERS

1 Control panel
3 Main switch
4,5,6 Program switches
7, 8, 9, 11 Display elements
13 Information switching element
15 Operating display element
17 Control device
19,22,23 Signal lines
25 Switches
26 Timing element
27, 28 Control lines
tₛₜₐᵣₜ Program start
t_{end} Program end
Δt₁, Δtₒₙ, Δt_{off} Time intervals

1-6. (canceled)

7. A household appliance comprising:
a control element structured to control the household appliance;
a power supply structured to supply power to the household appliance;
at least one display element structured to display at least one of an operating state and data about the household appliance; and
a control device structured to supply electrical energy from the power supply, by actuation of the control element, to the at least one display element, and at least one of reduce and interrupt the power supply to the at least one display element after a preset time period.

8. The household appliance as claimed in claim 7, wherein the control device is further structured to supply the at least one display element with the electrical energy at predetermined time intervals.

9. The household appliance as claimed in claim 7, further comprising an information switching element, wherein when the information switching element is actuated, the control device is further structured to restore the power supply to the at least one display element after the preset time period has elapsed.

10. The household appliance as claimed in claim 9, wherein the information switching element is disposed in a control panel of the household appliance together with the at least one display element.

11. The household appliance as claimed in claim 9, wherein the control device is further structured to at least one of interrupt and reduce the power supply to the display element once again when a further preset time period has elapsed after actuation of the information switching element.

12. The household appliance as claimed in claim 9, wherein the at least one display element includes an operating display element that indicates the operating state of the household appliance irrespective of at least one of the actuation of the information switching element and the at least one of reduction and interruption of the power supply to the at least one display element.

13. A method of controlling a household appliance comprising the steps of supplying electrical energy from a power supply, by actuation of a control element, to at least one display element, and at least one of reducing and interrupting the power supply to the display element after a preset time period.

14. The method as claimed in claim 13, further comprising the step of supplying the at least one display element with the electrical energy at predetermined time intervals.
